(19) United States
(12) Patent Application Publication
(10) Pub. No.: US 2016/0063570 A1
(43) Pub. Date: Mar. 3, 2016

(54) Interactive and intuitive marketing system and method for acquisition of personal data, dissemination of personalized content and social network promotion

(71) Applicants: Alex Minicucci, San Luis Obispo, CA (US); Luke A. Wallace, San Luis Obispo, CA (US)

(72) Inventors: Alex Minicucci, San Luis Obispo, CA (US); Luke A. Wallace, San Luis Obispo, CA (US)

(21) Appl. No.: 14/121,385

(22) Filed: Aug. 27, 2014

(51) Int. Cl. G06Q 30/02

(52) U.S. Cl. CPC G06Q 30/0271; G06Q 30/0229; G06Q 30/0233; G06Q 30/0237; G06Q 30/0267

(57) ABSTRACT

An intuitive and interactive marketing system and method for the acquisition of personal data via a loyalty kiosk and associated non-transitory computer-readable storage media having computer-executable instructions embodied thereon situated within a business environment to secure phone numbers and customer data for use in SMS/text marketing campaigns and related data mining and to permit automation of personalized marketing to customers as a function of input data and historical activities. The system and method further provide dissemination of marketing campaigns through social network interfaces and data/status updates of the market campaign based on business designated triggers.

### FIELD OF THE INVENTION

The present invention relates to the field of marketing and the acquisition of personal data via a loyalty kiosk and associated non-transitory computer-readable storage media having computer-executable instructions embodied thereon situated within a business environment to secure phone numbers and customer data for use in SMS/text marketing campaigns and related data mining to permit automation of personalized marketing to customers as a function of input data and historical activities. The system and method further provide dissemination of marketing campaigns through social network interfaces and data/status updates of the market campaign based on business designated triggers.

The present invention further relates to the field of interactive marketing and data acquisition to permit such marketing in particular, but not limited to, in a marketing and data acquisition system using short message services (SMS) proved on mobile devices such as cell phones or other telecommunication systems permitting SMS or other short code transmissions.

The present invention further relates to a consumer transaction in which a consumer is solicited at a point of transaction (POT) or other location within a business environment to provide personal data and more specifically telephone access information and authorization to permit transmission of rewards, loyalty program data, personalized marketing messages and other marketing campaign broadcasts to permit a customer to earn rewards by performing designated activities, including providing reviews and timely responses to the messages.

The present invention further relates to improved methods and systems for utilizing the information obtained from customers to create marketing opportunities and generate concomitant sales and more particularly to permit targeted marketing campaigns.

The present invention further relates to providing the consuming public with a viable interactive and intuitive survey, data providing and marketing system based on SMS messages and other short message modalities transmitted to mobile devices, such as cell phones, to provide consumers, and more specifically loyalty based customers, with broadcast and personalized options to entice the customers to continue participation in the programs.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

Advertising is a multi-billion dollar a year industry. Many companies invest heavily in advertising as a method of increasing their sales. Advertising, however, can be a very expensive undertaking. In particular, paying for advertising within major mediums, such as TV, radio, or internet, can cost a great deal of money.

Because advertising can be so costly, companies generally attempt to target their advertising to particular demographics. For example, during prom season a tuxedo rental shop may want to target its advertising to high school males. In contrast, a luxury car maker may want to target its advertising to middle aged professionals. Accordingly, luxury car advertisements that are read by high school males are likely not going to generate the carmaker any additional business. Similarly, it is unlikely that tuxedo rental advertisements read by middle aged professionals are going to generate any additional business for the tuxedo rental shop. One will appreciate that effectively targeted advertisements can provide a much higher return-on-investment than non-targeted broadly sweeping advertisements.

Many forms of targeted advertising currently exist within the market place. For example, television advertising is often priced and sold based upon the demographic that watches a particular show during which advertisements are being sold. Similarly, magazines are often directed towards particular demographics or activities. For example, magazines that discuss outdoor topics are likely ideal places to advertise for companies that deal in outdoor recreation. In contrast, advertising rock climbing equipment within a cooking magazine is not likely to have a high return-on-investment.

One particular form of targeted advertising that is gaining popularity is reward programs. In general, reward programs function by offering customers deals and/or special treatment if they sign-up for the rewards program. By enrolling customers into a rewards program, a company is able to build an in-house database of customer contact information that can be used in advertising. In many cases, these lists can be particularly valuable to a company because the list represents not only customers of the business, but represents customers who expressed a willingness to be contacted regarding sales and specials.

As an example of a conventional rewards program, a clothing store may offer its customers a store specific purchase card or credit card that will automatically give the customer a certain percentage off future purchases. If the customer agrees to join the rewards program, a store employee will often request some form of contact information. This information is entered into a database and is used to communicate future sales and special offers to the customer.

However there is often a lack of cohesive marketing plans and technology to identify and engage effectively with loyal customers. While a customer may agreed to join a rewards program, that does not necessarily ensure that the customer will continue to use that program or will remember it when they next go to the store. Moreover, it is consistently a challenge to acquire from customers, even those who are loyal, telephone numbers for delivery of offers and alerts via SMS or other forms of text delivery.

Typical methods of reward programs also lack Data to effectively suggest appropriate messaging to interested customers unless those customers have been long time buyers from a particular store and have consistently purchased certain items from that store. The prior art shows a lack of tools to facilitate the easy distribution of alerts and offers to multiple medias at one time and also the lack of effective data collection to analyze and measure the effectiveness of marketing efforts. In short, a method of acquiring sufficient data to permit effective and appropriate messaging to interested customers is necessary. The present invention overcomes these difficulties by actively engaging the customer through an intuitive loyalty kiosk system appropriately placed and providing immediate incentive to the customer to engage with the system.

As described above, this conventional method of reward programs based advertising provides several benefits and advantages. In some cases, however, a store may desire to have additional information about a customer that signs up for a rewards program. For example, a store may desire to know the gender, approximate age, and familial status of each customer on the rewards program. This can be beneficial when communicating sales and specials to customers in the rewards program.

For instance, using the clothing store example from above, the store may desire to send out an advertisement regarding a sale of women's swimwear. One will appreciate that the ability to target this advertisement to female members of the rewards program would be beneficial. Sending this advertisement to male members of the rewards program would likely generate little return, and further, could push a male rewards program member to cancel their membership. In many cases, individuals will cancel their membership in rewards programs if they are receiving too many advertisements or if they are receiving advertisements that contain sales that either do not interest them or do not apply to them.

Accordingly, there are a number of problems in the art relating to collecting information about customers and targeting advertisements to those customers that can be addressed by the use of personalized data and targeted transmission to a customer's device of choice, which today is often their mobile device.

Advances in communication technology have lead to an ability of cellular and digital telephone users to communicate without the typical restraints of conventional landline telephone use. Specifically, present wireless devices have the capacity to send and receive short-text messages through a short messaging service (SMS).

SMS traffic, in the U.S. in particular, has seen widespread popularity. In reaction to the wide adoption of SMS, advertisers have begun adapting the platform for marketing purposes. The one-to-one nature of advertising on a personal wireless device, as well as the instant nature of SMS messages, makes for an attractive marketing method. However, due in large part to the opt-in nature of SMS marketing, the process of promoting a mobile campaign to generate exposure still requires considerable resources. Often, advertisements are distributed widely with a mere hope that a potential customer will receive the advertisement, and are not often used with qualified advertising leads.

Advertising or sales leads are terms used to refer to potential customers who may be particularly interested in a product or service. Historically, advertising leads are generated by direct marketing (including Internet marketing) and/or cold calling. Generally, advertising leads do not have much value unless the lead is qualified or otherwise characterized as a sales prospect. For example, advertising leads may be qualified by identifying (such as by direct interrogation) the lead's product applicability, availability of funding, and time frame for purchase.

Online integration with various communication devices is creating new realms for advertisers and other content providers. Marketing campaigns in the past have been mostly focused on television, radio, paper media and internet. Today's advertisers are seeking a more tailored and personalized approach. Rather than bombarding the masses with general interest ads, the advertisers are slowly becoming more focused on selected groups of people that have a common interest in a particular subject, product or service. This is proving to enable both higher returns on investment (ROI) on the part of the advertiser, as well as less annoyance and frustration on the part of the consumer.

In this context, some industry rivalries are beginning to emerge between network operators (e.g. T-Mobile, Verizon Wireless, AT&T, etc.) on the one hand and internet service providers (ISPs), online ad vendors and various other content providers on the other. While ad server vendors, such as Google, have shown a very successful business model in online advertising, network operators have played a much less significant part in targeting ads. Yet network operators are uniquely and favorably positioned in the marketplace for obtaining various information and managing diverse relationships between a multitude of players. In addition to having access to the user's preferences and data, the operator also controls many aspects of the communication transmission in the network. For example, the network operator owns the mobile cellular network and its hardware elements (SMS-C, MMS-C, etc) as well as the information regarding its subscribers. As new services and products emerge, it is desirable for network operators to manage and monetize their position in order to continue to be able to compete in the future.

One area of potential improvement in this environment arises from the need for the network operator to integrate any sort of mobile communications advertising system with existing business management systems typically used by enterprises. For example, it is desirable that marketing and advertising seamlessly integrate with existing business tools such as business process execution language (BPEL) based systems, business intelligence (BI), Billing and Revenue Management (BRM) and business activity monitoring (BAM) systems.

Mobile telecommunications are now extremely popular. There are now more than two billion GSM (Global System for Mobile) subscribers worldwide. Usage has evolved from a purely voice-oriented model to data communications, messaging (Short Messaging Service (SMS)), multimedia (Multimedia Messaging Service (MMS)), and browsing (Wireless Application Protocol (WAP)).

From the point of view of advertisers, mobile devices are an attractive channel of communication. However, at the present time there are surprisingly few techniques for delivering advertisements to mobile users in a way that is cost-effective, unobtrusive, and compliant with regulations. The present invention provides such techniques. Prior art advertising on mobile devices typically proceeds via SMS or WAP, often in unwanted or mass transmissions which may be counterproductive and not properly targeted to the particular receiving audience or portions of that audience.

SMS marketing campaigns consist in sending massive amounts of short text messages to mobile users. In case a mobile user wishes to request more information or to accept a promotional offer, the short text messages typically contain instructions for calling a telephone number, replying with another SMS message, or accessing a WAP site.

Advertising on WAP services is very similar to advertising on the World Wide Web (WWW). Both textual and graphical marketing messages can be added to WAP pages. “Click-through” hyperlinks allow users to access further information.

Other methods of delivering advertisements to mobile devices include the following. U.S. patent application Ser. No. 09/907,629 by Blom discloses a method involving an advertisement broker who obtains advertisements from advertisers and provides those advertisements to mobile users. But an advertisement is only provided to mobile users whose positions lie within a location associated with that advertisement, and the advertisement is sent to mobile users via email, which may not be supported by some mobile devices.

U.S. patent application Ser. No. 09/907,899 by Gledje discloses a method whereby a service provider delivers advertisements to mobile users who are located in zones associated with those advertisements, who satisfy various demographic criteria, and who have subscribed to an advertising service. But many countries have privacy regulations that forbid provision of such location and demographic information to service providers. Further, location- and subscriber-based approaches are not appropriate for some types of advertising.

Current advertising on mobile devices faces a number of problems. Among these are the following:

1. The screens of mobile devices are much smaller than those of computers. Consequently, large advertisements may appear obtrusive, and small advertisements may go unnoticed.

2. Due to the nature of wireless networks, delivering advertising content to mobile devices is costly, either to the advertiser, to the mobile operator, or to the mobile user. It is more expensive to send SMS messages than to send emails, and mobile users are typically billed for the volume of WAP data they receive, which includes advertisements.

3. Unlike television viewers and computer users, mobile device users tend to look at their mobile devices only when they need to perform a specific task, such as answering or initiating a voice call, receiving or sending a Short Message, or accessing a WAP service. Moreover, it is difficult to divert the attention of mobile device users when they are about to perform one of these tasks.

4. Advertisements are most useful if they provide a way for recipients to respond to promotional messages immediately and at no cost. In most networks, sending a SMS reply or accessing a WAP page achieves the former objective but not the latter.

5. Advertisers need statistics to measure the effectiveness of their marketing campaigns.

6. When an advertisement is inserted into an existing service, the provider of that service desires to receive compensation for providing advertising space to the advertiser.

7. Mobile device users generally consider advertising messages to be an annoyance. Consequently, mobile operators are reluctant to allow advertising on their networks, for fear of losing customers.

8. Advertising is most effective when it is carefully targeted. However, many countries have strict regulations regarding privacy. Consequently, advertisers cannot have access to all of the relevant information, such as the identities and locations of users.

Micromarketing is the practice of tailoring products, brands, and promotions to meet the needs and wants of microsegments within a market. Micromarketing channels include Internet technology, such as email and any form of advertising on the World Wide Web (including targeted ads), as well as mobile technology including SMS and any form of advertising on mobile phones.

A major problem in mobile advertising is that advertising messages are viewed as spam, and clutter up SMS or MMS inboxes. Because the advertising messages also consume valuable memory, they cause users to delete or manage these messages (wasting their precious time) or cause users to subscribe to do-not-call or do-not-sms lists. Pull-based or subscription-based methods for mobile ads also present problems. They still result in cluttered SMS or MMS in-boxes, causing users to delete or manage the messages, and there is still the spam perception.

If it were possible to remove the spam perception of mobile marketing, and increase user-control, this would significantly increase the likelihood of users adopting and responding to mobile marketing of various kinds (push/pull, location/context aware, etc).

### BRIEF SUMMARY OF THE INVENTION

In one aspect, the present invention provides an intuitive and interactive marketing system and method for the acquisition of personal data via a loyalty kiosk and associated non-transitory computer-readable storage media having computer-executable instructions embodied thereon situated within a business environment to secure phone numbers and customer data for use in SMS/text marketing campaigns and related data mining to permit automation of personalized marketing to customers as a function of input data and historical activities.

In another aspect, the system and method further provide for the dissemination of marketing campaigns through social network interfaces and data/status updates of the market campaign based on business designated triggers.

In yet another aspect, the present invention provides for the creation of a cohesive marketing plan and technology to identify loyal customers and to maintain that loyalty by providing targeted and personalized incentives and rewards that will continue to engage them.

It is yet another aspect of the aspect of the present system and method of the invention to solicit customers to provide personal data, in compliance with regulations and laws relating to the use of such personal data, to enable merchants to effectively engage customers and provide appropriate messaging to get them to behave in a particular manner and thereby earn rewards and incentives by such behavior.

In yet another aspect of the invention, a customer visiting a participating merchant who is advertising through the system and has a loyalty kiosk will be solicited to check into the kiosk and will thereafter receive a targeted message via SMS or other messaging methodology. The message will thank them for the visit to the merchant, thus acknowledging their loyalty, and create a new reward for a response to the message's request of, for instance, providing a review of the visit experience.

The invention further relates to the creation of one or more location based offers or rewards in which a customer is solicited to check into the kiosk and will thereafter receive a targeted message via. SMS or there messaging methodology based upon the perceived location of the kiosk. The message will ask the customer for a response and, upon obtaining that response will generate a reward for the customer and will add the review to any of a number of pre-determined area that relate to the marketing campaign, such as a Facebook posting, loyalty network website or other advertiser designated location.

The invention further relates to the aggregation of data from multiple input sources to generate automated personalized marketing campaigns and functions via one or more non-transitory computer-readable storage media having computer-executable instructions embodied thereon, wherein when executed by at least one processor, the computer-executable instructions cause the at least one processor to acquire data relative to a customer to permit the generation of one or more loyalty/reward messages to the customer based on the customer's habits, triggers and inputs.

The system and method of the present invention further provides computer-executable instructions within the non-transitory computer readable storage media to permit the further requesting of customer data, the loading of customer data and the evaluation of the customer data in order to permit the generation of appropriate loyalty/reward messages to the customer.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is an illustrative embodiment of an interactive marketing system in accordance with the method, system and programs of the present invention.

FIG. 2 is a block diagram that illustrates a preferred embodiment of an interactive marketing system for securing and processing customer data and actions in accordance with the method, system and programs of the present invention.

FIG. 3 is a high level flowchart and block diagram illustrating a system and method for individualizing and delivering messages and for otherwise employing an interactive marketing system for securing and processing customer data and actions in accordance with the method, system and programs of the present invention.

### DETAILED DESCRIPTION OF A PREFERRED EMBODIMENT

Some embodiments described herein involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The above examples are exemplary only, and thus are not intended to limit in any way the definition and/or meaning of the term processor.

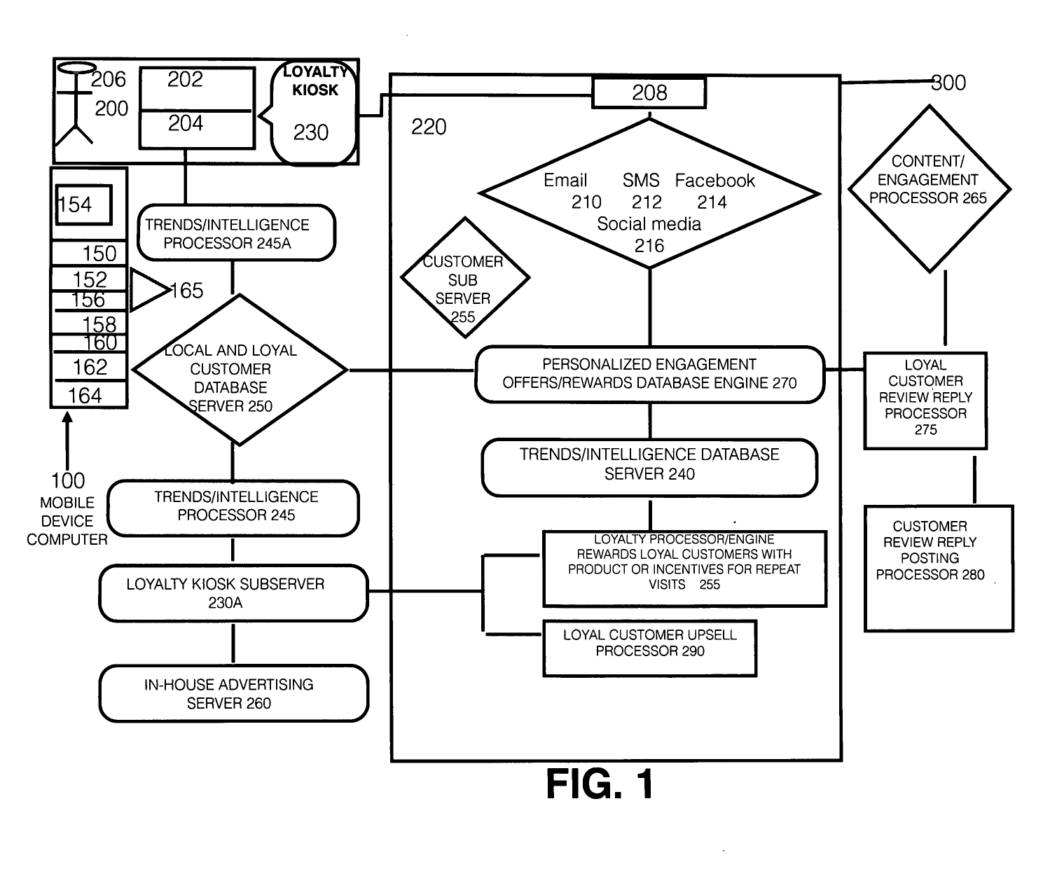

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor”, “server” or “engine”). The functions these blocks represent may be provided through the use of either shared or dedicated hardware, including, but not limited to, hardware capable of executing software. For example, the functions of one or more processors presented in FIGS. 1-3, may be provided by a single shared processor or multiple processors. Use of the terms “processor” or “server” or “engine” should not be construed to refer exclusively to hardware capable of executing software.

In one or more exemplary embodiments provided herein, the programmed instructions may be generated as a group of co-operative software modules, each having its dedicated functions. The descriptions of such modules will allow one of ordinary skill in the art to readily appreciate the programming instructions required for implementing the disclosed processes herein. However, the programmed instructions themselves can be implemented in wide array of ways, depending, for example, on the operating system and software applications/environments selected, as well as on designer preference.

Such electronic or computing devices also typically include a memory coupled to the processor. The memory may include one or more tangible, non-transitory, computer readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory.

The terms “processor” or “server” or “engine” as used herein are broadly defined as one or more processing units of any type for performing all arithmetic and logical operations and for decoding and executing all instructions related to facilitating an execution of the various methods of the present invention. Additionally, the term “memory” as used herein is broadly defined as encompassing all storage space in the form of computer readable mediums of any type.

The methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, such as a firmware, physical and virtual storage, CD-ROMs, DVDs and another digital source such as a network or the Internet, as well as yet to be developed digital means, with the sole exception being a transitory, propagating signal.

In the one form of the present invention, the system comprises a processor and a memory storing data and information about the customer and/or the merchant and/or the campaign specifics and the data related to each of those along with a network communication system storing customer information that is related to each merchant with whom the customer interacts. The processor and memory store instructions operable with the processor for executing an interaction among the distinct modules to facilitate a communication between the customer and the campaign via SMS or other messaging protocol and generation of appropriate rewards and incentives for defined actions.

The instructions are executed to permit the communication and to obtain at least some information back from the customer in order to provide feedback both as to the actions of the customer and to maximize the effectiveness of the messaging. The information that is received from a client is employed to update the campaign profile relative to that customer in order to individualize the messages as well as generating campaign data to permit the merchant to better manage the campaign and influence future campaigns and the language and motivational parameters of the current campaign.

Illustrated in FIG. 1 is one implementation of a computing device 100 such as any computing device described herein. Computing device 100 can include a central communication bus 150 that communicates with each of the components included in the computing device 100. These components can include: an input/output (I/O) control 152; a display device 154; a network interface 156; a storage repository 158; a main processor 160; cache 162; and memory 164. The main processor 160 can include elements such as one or more I/O ports, or a memory port 165.

Further referring to FIG. 1, and in more detail, in some implementations the computing device 100 can be any computing device 100 having a processor 160. The computing device 100 can be a mobile device such as a laptop, netbook, smart phone, electronic reader, cell phone, personal digital assistant, tablet computer or any other hand-held computing device comprising a processor 160. In some implementations, the computing device 100 can be any hand-held mobile device able to carry out the methods and systems described herein. In some implementations, the computing device 100 can be a computer, a client computer, a server, or any other machine comprising a processor 160 able to execute computer readable instructions. The computing device 100, in some implementations, can be referred to as a computer, a computing machine, a machine, a device, a mobile device, or a mobile device.

The processor 160 included in the computing device 100 can be referred to as a central processing unit (CPU) or as a main processor. In some implementations, the processor 160 can include a single processing core, while in some implementations the processor 160 can include multiple processing cores. When the processor 160 includes multiple processing cores, the cores can execute in parallel and can access a shared memory location or individual memory locations assigned to particular cores. In some implementations, the computing device 100 can include multiple processors 160. When the processor 160 includes multiple processing cores or multiple processors, the processors can execute a single instruction simultaneously on multiple pieces of data (SIMD), or in some implementations can execute multiple instructions simultaneously on multiple pieces of data (MIMD).

In one implementation, the processor(s) 160 can be any processor. In some implementations, the processor(s) 160 can be any combination of a microprocessor, a microcontroller, programmable logic gates, or any other processor. The processor 160, in some implementations, can further comprise a graphics processing unit (GPU) which can include any combination of hardware and processor-executable instructions for processing graphics data and graphics commands. In some implementations, the processor 160 can further comprise a graphics engine or any other processing engine.

Referring again to FIG. 1 there shown a customer 200 at a point of transaction device 202 having a user interface 204 within a network communication system 220. The point of transaction device 202 is ideally located within a merchant establishment 206. A telecommunications system 208 is interconnected to a series of communications means such as e-mail 210, SMS 212, Facebook pages 214 and other social media/telecom modulated systems 216.

A loyalty kiosk 230 is advantageously disposed in proximity to the point of transaction device 202 in order to permit the customer 200 to see the various campaign information which is packaged and displayed appropriately in the loyalty kiosk 230 of the particular merchant establishment 206. Thus, for example, if a customer 200 has gone into a merchant establishment 206 where they generally go to purchase clothes, appropriate campaign information will be displayed at the loyalty kiosk 230 so that the customer 200 will see it and will be prompted to enter their telephone number and interact with the loyalty kiosk 230.

As a further part of the system, the loyalty kiosk 230 may also request additional customer data from the customer 200 at the same time that it is displaying the campaign information to that customer. Thus, by way of example, the loyalty kiosk 230 may ask for an update of the customer 200 E-mail address or suggest that an incentive or other discount maybe available which is related to the customer 200 current purchase.

At the time that the customer 200 enters their telephone number and customer data, the system 220 will enter the telephone number and related data into both a database 250 of local and loyal customers and provide individual database of personalized engagement offers and rewards through a sub-database 255 which is designed for the individual customer 200. The sub database 255 maybe a part of the main database 250 or maybe a register maintained separately from the main database 250.

Once the customer 200 enters their telephone number, it permits a main trends/intelligence processor 245 to determine when the customer 200 had last been at the merchant establishment 206, what their prior purchase had been and to otherwise permit the aggregation of data on that customer 200. As a further part of the system, a core database server 300 structure aggregates data from multiple input sources which relate to the customer 200 who has entered their telephone number.

Thus, by way of example, the core database structure 300 may determine that the customer 200 has not been purchasing clothes recently as seen by the fact that the customer 200 has not frequented a clothing store to which they are loyal. The system may determine that the customer 200 has almost earned a reward in the particular store and thereby would send an “Almost Earned Reward” text/notification to remind the customer of their participation within that loyalty program and entice them to continue to participate.

Similarly, the core database structure of the SMS marketing engine 300 may determine that a customer 200 has been inactive in purchasing at any of the number of stores who are participants in the intuitive marketing system. The core database 300 would then initiate an “Inactive Customer” text/notification message to remind that customer 200 that they have not interacted with the system for a specified period of time and remind them of the benefits and rewards that come with participation within the loyalty program, thus enticing them to come back to the store or stores are participating in the loyalty system.

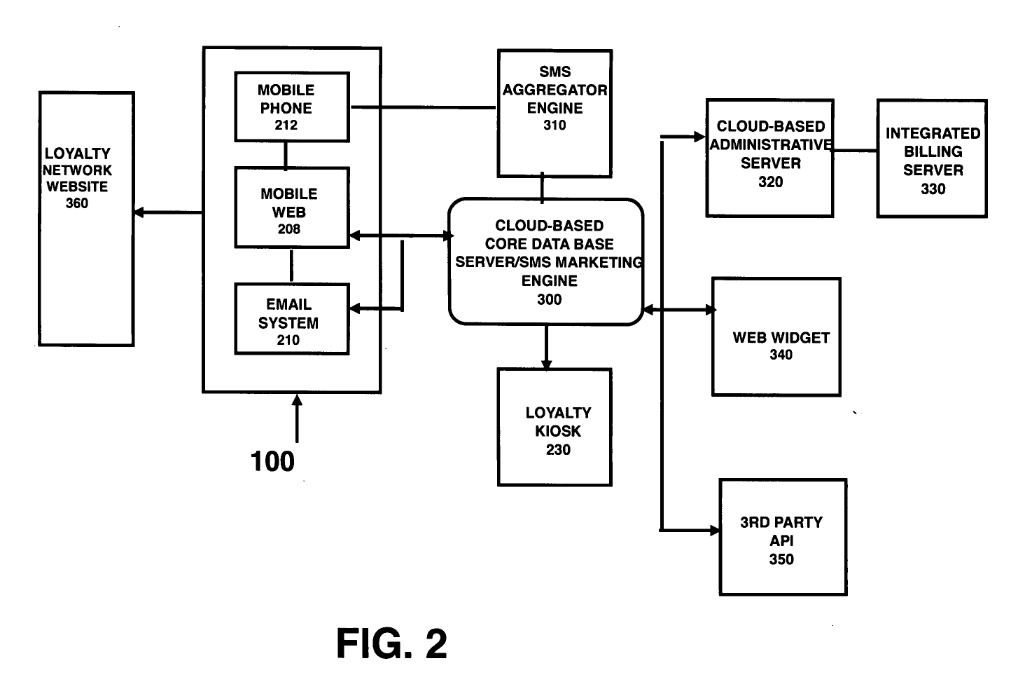

Referring to FIG. 1 and FIG. 2, there is shown an illustrative preferred embodiment of an interactive marketing system for securing and processing customer data and actions in accordance with the method, system and programs of the present invention in which the various components of the intuitive marketing system are functionally described. Referring to the loyalty kiosk 230, the customer 200 is shown campaign information which is displayed and packaged appropriately for the specific kiosk in the merchant establishment 206. Thus, by way of example, the campaign information for a clothing store which is participating in a loyalty program would be different from the campaign information displayed in the loyalty kiosk at a restaurant.

When the customer 200 interacts with the loyalty kiosk 230, the kiosk triggers data and event changes in real-time to be other elements of the intuitive marketing system. Thus, by way of example, when the customer 200 interacts with the loyalty kiosk 230 at a restaurant which they generally frequent, the information updates the intuitive cloud-based database 300 for the particular user records which are unique to customer 200. The database shows that the customer 200 may belong to one or more campaigns and the relationship between those campaigns. At the same time, the core database structure 300 will aggregate information on the campaign to provide feedback to the advertiser as to the number of times that users have participated in the campaign via the loyalty kiosk. Thus the information is both specific and sufficiently general to permit what it made campaign management based upon customer habits and triggers and permit filtering of messages to the customer within the loyalty program.

As a further aspect of the database and the processor associated therewith, an analysis of the data points is undertaken to determine the quality and effectiveness of an individual broadcast in order to permit that specific broadcast to be updated and have the language of future broadcasts be influenced. By way of example, if a broadcast contains a certain phrase and it is found that customers do not respond to that broadcast, that phraseology maybe changed in subsequent iterations of the campaign to permit the employment of phrases and language that customers have been found to respond to.

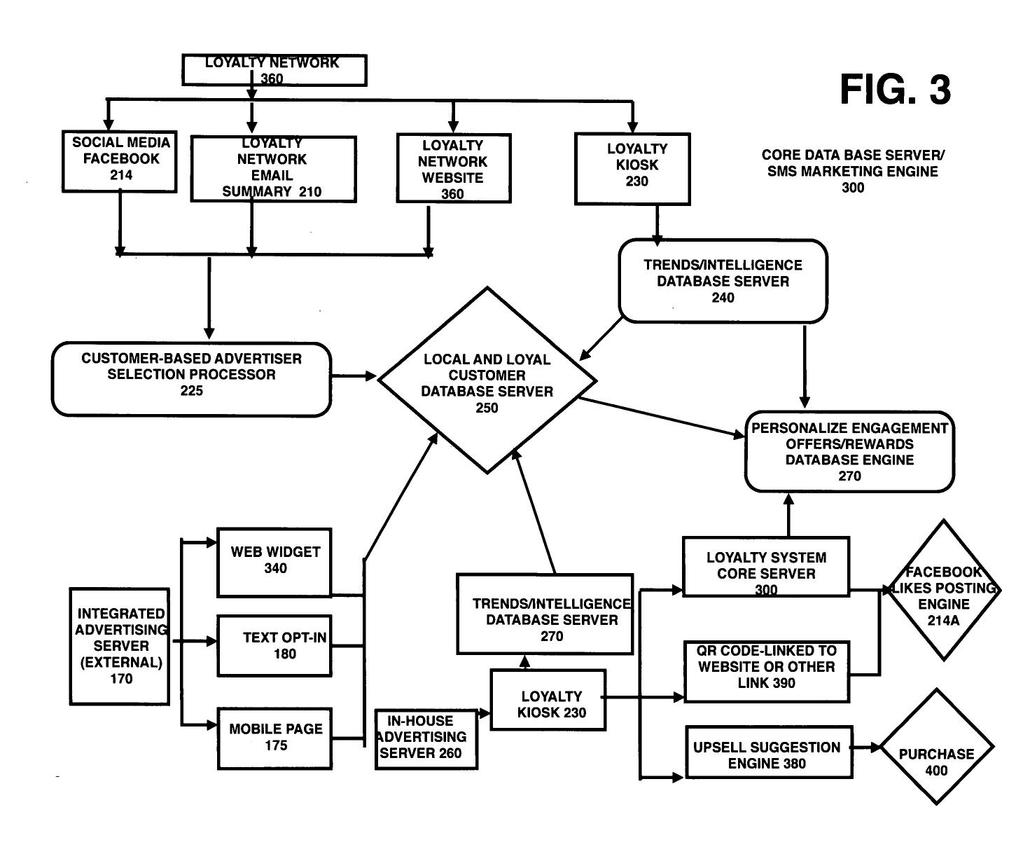

Continuing to refer to FIG. 1, FIG. 2 and FIG. 3, the cloud-based core database structure 300, after having been activated by customer's 200 use of the loyalty kiosk 230, triggers an SMS aggregator 310. The SMS aggregator 310 constitutes a message sending engine which directs that a message be sent to the computing device 100, and ideally to a mobile phone or similar mobile device to permit two-way interaction thereby permitting the sending and receiving messages and trigger functions with special commands.

While the preferred methodology for interaction with customer 200 is via a mobile computing device 100, the campaign information is not limited solely to mobile phones. Thus, by way of example, the campaign information maybe repurposed and designed into mobile friendly webpages with unique URLs or may be provided via an e-mail system 210 or mobile web 208 for those consumers who indicated a preference to receive campaign communications via those mediums. Once the customer 200 visits an advertiser who has a loyalty kiosk 230, and interact with that loyalty kiosk 230 by checking in with their telephone number, they earn points towards obtaining some reward or incentive. Generally the reward will be related to the advertiser whose kiosk 230 they are accessing.

Thereafter, the customer may receive a text message which thanks them for having visited the particular advertiser today. In order to further secure the customer's loyalty and reinforce the interactive nature of experience, a text could also ask, through a review/reply processor 275 that the customer 200 reply with a quick review of their visit and experience to earn additional points towards your reward. The customer 200, by replying to the text message request, will provide a review of the experience to the advertiser at the merchant location 206. A customer review/reply posting processor 280 accepts the customer's 200 incoming message and, based upon predetermined preferences for the campaign will add that review to variety of additional advertising elements such as a network loyalty website, the advertiser's website, the advertiser's Facebook page and similar advertising media through a content/engagement processor 265.

As can be seen as part of the above illustration, a review after being properly filtered in order to ensure that it is favorable or meets other criteria predetermined by the advertiser and the campaign setup, can be posted and connected to the advertiser's Facebook page 214 and simultaneously provide the advertiser with status updates in order to permit the advertiser to evaluate the efficacy of the campaign via a trends/intelligence database server 240. That efficacy may be based upon the total participation in the loyalty campaign, the number of people checking in and responding in a given day or over a period of time or such other criteria as maybe determined by the advertiser.

As a further part of the cloud-based core database 300 and the SMS marketing aggregator engine 310, the activation and interaction with the loyalty kiosk 230 directs an interaction with a cloud-based administrative system 320 which displays real-time reporting and allows for the real time manipulation of client campaigns and consumer data. The cloud-based administrative system 320 operates in conjunction with an integrated billing module 330 which, based upon various predetermined actions determines appropriate billing amounts and completes a full credit card charge or invoice record for the merchant.

As yet a further part of the SMS marketing engine 300, a web widget module 340 maybe advantageously deployed to embed pieces of website code into various websites to add bidirectional functionality with the cloud-based database. That bidirectional functionality permits connections between the cloud-based database and the SMS marketing engine to third-party systems via third-party APIs 350.

Yet a further element of the SMS marketing engine 300 is a loyalty network website 380 which permits campaign information to be updated in real-time on both regional and national websites thus permitting advertisers to obtain data on various campaigns and to permit the determination of whether a campaign is functioning regionally as well as nationally.

It can be appreciated that the advertising and related data provided to a customer 200 on the loyalty kiosk 230 may be via an in-house advertising server 260 employed by the merchant establishments 206. Alternatively integrated external advertising server 170 may provide the advertising and related data on the loyalty kiosk 230. In either case, the advertising is directed to the loyalty kiosk 230 and requests that the customer 200 opt in to receive text or other messages to there mobile device 100 of choice.

As can be seen illustratively in the figures, a trends/intelligence database server 240 captures the information provided through each of the loyalty kiosks 230 and provides that data to a local and loyal customer database server 250. The local and loyal customer database server 250 aggregates and extrapolates the customer 200 data and provides personalized engagement offers and rewards through an offer/rewards database engine 270.

The trends/intelligence database server 240 also provides the SMS marketing system 300 with the ability to direct the customer 200 two other websites for links 390. It also has the capacity to determine, By the history and nature of a customer 200 activity the possibility of providing an upsell suggestion via an upsell suggestion engine 380. The customer 200 will view both the reward at the loyalty kiosk 230 and A suggestion for an immediate purchase through the upsell suggestion engine 380. In the event such A suggestion is followed a purchase 400 results in the immediate posting of revenue to the merchant establishment 206.

Although the loyalty kiosk 230 at any given merchant establishment 206 is generally one which provides loyalty incentives for the particular merchant establishment 206, a customer 200 make choose to request that the information displayed at a loyalty kiosk 230 relates to or be derived from an advertiser different from the merchant establishment 206 housing the loyalty kiosk 230. Thus, a customer 200 may request, through a customer based advertiser selection processor 225, that they receive related information such as promotional information on hiking shoes based upon the fact that the customer 200 has just purchased outdoor camping equipment and is looking forward to taking a hiking vacation.

Although the present disclosure has been described with reference to preferred embodiments, persons skilled in the art will recognize that changes may be made in form and detail without departing from the spirit and scope of the disclosure. For example, it is'recognized that multiple embodiments of rewards or incentives or other communication methodologies may be suitable for use with the system and method of the present disclosure. Furthermore, although the present disclosure relates to loyalty kiosks, the benefits and incentives are not limited to loyalty kiosks, but extends to loyalty input systems whereby a customer demonstrates their loyalty to a merchant or series of merchants and is receives either individual or aggregate incentives. The system may also be employed to elicit reward based activities other than from the purchase of goods, such as providing reviews and other positive response data to permit the enhancement of a merchant's reputation and provide affirmations and recommendations in a social media context.

What is claimed is:

1. An automated loyalty marketing system comprising:
a. a loyalty kiosk situated at a merchant establishment that communicates with a loyalty recipient customer over a network interface with a loyalty rewards data base upon activation by said loyalty recipient customer;
b. a processor having a memory for storing profile and loyalty activity data for at least one loyalty recipient customer, said processor administering a plurality of loyalty awards benefit programs to which the at least one loyalty recipient customer is enrolled;
c. an award benefits administration engine having different award benefits rules applicable to each of a plurality of merchants to administer a plurality of award benefits programs sponsored by said plurality of merchants and generate personalized offers and awards to the at least one loyalty recipient customer;
d. loyalty kiosk activation means through a customer unique identifier;
e. acquiring means to secure and transmit a customer supplied address to said processor and transmit data to the customer at the supplied address at a location remote from the loyalty kiosk;
f. a loyalty benefits processor capable of validating the loyalty recipient customer's activation and selecting an appropriate personalized advertisement, offer or reward based upon both merchant and customer advertisement, offer or reward benefit criteria;
g. a trends/intelligence database server capable of evaluating the loyalty recipient customer's advertisement, offer or reward, the response thereto and aggregating the responses of loyalty recipient customers to revise and update advertisements, offers and rewards for transmission upon subsequent loyalty kiosk activations.

2. An automated marketing system of claim 1 wherein the plurality of award benefits programs sponsored by said plurality of merchants are correlated to provide each of the plurality of merchants with data relative to each of the loyalty recipient customers.

3. An automated marketing system of claim 1 wherein an award benefit is provided to the loyalty recipient customer upon activation of the loyalty kiosk by the loyalty recipient customer.

4. An automated marketing system of claim 3 wherein a second award benefit is provided to the, loyalty recipient customer through the customer supplied address at a location remote from the loyalty kiosk.

5. An automated marketing system of claim 1, additionally comprising means to deliver a personalized message at the loyalty kiosk relating to the loyalty recipient customer's account.

6. An automated marketing system of claim 1, comprising means to deliver a personalized message to the customer supplied address at a location remote from the loyalty kiosk relating to the loyalty recipient customer's account.

7. An automated marketing system of claim 1, comprising means to deliver a personalized message to the customer supplied address at a location remote from the loyalty kiosk relating to a reward available to the loyalty recipient customer.

8. An automated marketing system of claim 1, wherein the personalized message to the customer supplied address is delivered to a mobile communication device.

9. An automated marketing system of claim 5, further comprising an upsell processer wherein the personalized message provides an immediate sales proposal to the loyalty recipient customer.

10. An automated loyalty marketing method implemented by a loyalty recipient customer comprising:
a. activating a loyalty kiosk situated at a merchant establishment by the loyalty recipient customer to communicate over a network interface with a loyalty rewards data base upon activation by said loyalty recipient customer;
b. storing profile and loyalty activity data for at least one loyalty recipient customer, said processor administering a plurality of loyalty awards benefit programs to which the at least one loyalty recipient customer is enrolled;
c. activating an award benefits administration engine having different award benefits rules applicable to each of a plurality of merchants to administer a plurality of award benefits programs sponsored by said plurality of merchants and generate personalized offers and awards to the at least one loyalty recipient customer;
d. activation the loyalty kiosk through a customer unique identifier;
e. acquiring, securing and transmitting a customer supplied address to said processor and transmitting data to the customer at the supplied address at a location remote from the loyalty kiosk;
f. validating the loyalty recipient customer's activation and selecting an appropriate personalized advertisement, offer or reward based upon both merchant and customer advertisement, offer or reward benefit criteria; and,
g. evaluating, via a trends/intelligence database server, the loyalty recipient customer's advertisement, offer or reward, the response thereto and aggregating the responses of loyalty recipient customers to revise and update advertisements, offers and rewards for transmission upon subsequent loyalty kiosk activations.

11. The automated marketing method of claim 10 comprising correlating the plurality of award benefits programs sponsored by said plurality of merchants to provide each of the plurality of merchants with data relative to each of the loyalty recipient customers.

12. The automated marketing method of claim 10 wherein an award benefit is provided to the loyalty recipient customer upon activation of the loyalty kiosk by the loyalty recipient customer.

13. The automated marketing method of claim 10 wherein a second award benefit is provided to the loyalty recipient customer through the customer supplied address at a location remote from the loyalty kiosk.

14. The automated marketing method of claim 10 wherein a personalized message is delivered at the loyalty kiosk relating to the loyalty recipient customer's account.

15. The automated marketing method of claim 10 wherein a personalized message is delivered to the customer supplied address at a location remote from the loyalty kiosk relating to the loyalty recipient customer's account.

16. The automated marketing method of claim 10 wherein a personalized message is delivered to the customer supplied address at a location remote from the loyalty kiosk relating to a reward available to the loyalty recipient customer.

17. The automated marketing method of claim 10 wherein a personalized message is delivered to the customer supplied address is delivered to a mobile communication device.

18. The automated marketing method of claim 10 wherein a personalized message is delivered to provide an immediate sales proposal to the loyalty recipient customer.
